(19) United States
(12) Patent Application Publication
(10) Pub. No.: US 2017/0072973 A1
(43) Pub. Date: Mar. 16, 2017

(54) SYSTEM AND METHOD FOR PERFORMING ASSET MANAGEMENT OF A LOCOMOTIVE CONSIST

(71) Applicant: Electro-Motive Diesel, Inc., LaGrange, IL (US)

(72) Inventors: Alexander Shubs, Chicago, IL (US); David Matthew Roenspies, Elburn, IL (US)

(73) Assignee: Electro-Motive Diesel, Inc., LaGrange, IL (US)

(21) Appl. No.: 14/851,025

(22) Filed: Sep. 11, 2015

(51) Int. Cl. B61L 27/00; G06F 3/0481; B61L 27/02

(52) U.S. Cl. CPC B61L 27/0061; B61L 27/02; G06F 3/0481

(57) ABSTRACT

Systems and methods using a controller and a graphical user-interface are provided for managing assets in a locomotive consist. Embodiments of the invention also provide asset management instructions embedded on a non-transitory computer readable medium for managing the assets by providing selectable options to a user for accomplishing wireless management of the assets in the locomotive consist.

### TECHNICAL FIELD

The present disclosure relates to a locomotive, and more particularly, to a system for asset management in a locomotive consist.

### BACKGROUND

A locomotive consist typically includes various types of assets such as, locomotives, revenue cars, fuel tenders, lube cars, and the like. In some cases, the locomotive consists may be autonomously operated i.e., with the help of a remotely located operator. In such cases, it may be desirable to provide the remotely located operator with wireless facilities that help facilitate the operator in managing the assets present in the locomotive consist.

For reference, U.S Publication 2014/0026089 (hereinafter referred to as '089 publication) relates to systems and methods for providing a graphical interface and application for managing assets in an asset zone such as a yard, a port, a warehouse, or a lot. Embodiments disclosed in the '089 publication provide an asset management software application configured to manage assets pro-actively by maximizing visibility of the asset zone and by providing selectable options to a user to improve operations across the asset zone.

### SUMMARY OF THE DISCLOSURE

In one aspect of the present disclosure, a system for performing asset management of a locomotive consist includes a controller that is configured to receive an asset identification value and a position value for each asset from a plurality of assets present in the locomotive consist. The controller is further configured to display, at a graphical user interface (GUI), a navigable visual representation of the locomotive consist based on the asset identification value and the position value associated with each asset present in the locomotive consist. The controller is also configured to receive, at the GUI, a command on the visual representation of the locomotive consist for navigating and requesting a specific asset to be called into a user-selectable area of the GUI. The controller is then configured to display, at the GUI, at least one characteristic pertaining to the specific asset in response to the specific asset being called into the user-selectable area of the GUI. Thereafter, the controller is configured to receive, at the GUI, at least one input for modulating the at least one characteristic pertaining to the asset displayed in the user-selectable area of the GUI. The controller is then configured to modulate, at the locomotive consist, the at least one characteristic pertaining to the asset displayed in the user-selectable area of the GUI based on the received input.

In another aspect of the present disclosure, embodiments of the present disclosure are also directed to a computer-implemented method for performing asset management of a locomotive consist.

In yet another aspect of the present disclosure, embodiments of the present disclosure are also directed to a non-transitory computer-readable medium having stored thereon sequences of instruction which when executed by a computer-based system for performing asset management of a locomotive consist, causes the computer-based system to execute operations consistent with the present disclosure.

Other features and aspects of this disclosure will be apparent from the following description and the accompanying drawings.

### BRIEF DESCRIPTION OF THE DRAWINGS

FIG. 1 is a schematic representation of a locomotive system, in which embodiments of the present disclosure can be implemented;

FIGS. 2A-2B are diagrammatic views of an exemplary customizable portable computing device for providing user-selectable options pertaining to an operation of the locomotive system, in accordance with various embodiments of the disclosure;

FIG. 3 is a schematic representation of a remote operator center facilitating communication between the locomotive and a system for controlling operation of a fuel-supply system associated with a locomotive;

FIG. 4 is a computer-implemented method showing steps for remotely controlling the fuel-supply system, according to an embodiment of the present disclosure; and

FIG. 5 is a block diagram of an exemplary computer system, according to an embodiment of the present disclosure.

### DETAILED DESCRIPTION

The detailed description of exemplary embodiments of the disclosure herein makes reference to the accompanying drawings and figures, which show the exemplary embodiments by way of illustration only. While these exemplary embodiments are described in sufficient detail to enable those skilled in the art to practice the disclosure, it should be understood that other embodiments may be realized and that logical and mechanical changes may be made without departing from the spirit and scope of the disclosure. It will be apparent to a person skilled in the pertinent art that this disclosure can also be employed in a variety of other applications. Thus, the detailed description herein is presented for purposes of illustration only and not of limitation. For example, the steps recited in any of the method or process descriptions may be executed in any order and are not limited to the order presented. As such, other alternatives can also be provided to the method or process descriptions where one or more steps are added, one or more steps are removed, or one or more steps are provided in a different sequence without departing from the scope of the claims herein.

For the sake of brevity, conventional data networking, application development and other functional aspects of the systems (and components of the operating systems) may not be described in detail herein. Furthermore, the connecting lines shown in the various figures contained herein are intended to represent exemplary functional relationships and/or physical/communicative couplings between the various elements. It should be noted that many alternative or additional functional relationships or physical/communicative connections may be present in a practical system.

The present disclosure is described herein with reference to system architecture, block diagrams and flowchart illustrations of methods, and computer program products according to various aspects of the disclosure. It will be understood that each functional block of the block diagrams, the flowchart illustrations, and combinations of functional blocks in the block diagrams, the flowchart illustrations, and combinations of functional blocks in the block diagrams, respectively, can be implemented by computer program instructions.

These computer program instructions may be loaded onto a general-purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce output/s that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. It should be further appreciated that the multiple steps as illustrated and described as being combined into a single step for the sake of simplicity may be expanded into multiple steps. In other cases, steps illustrated and described as single process steps may be separated into multiple steps but have been combined for simplicity.

It may be further noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments whether or not explicitly described.

The systems, methods and computer program products disclosed in conjunction with various embodiments of the present disclosure are embodied in systems, modules, and methods for controlling operation of a machine. Specific nomenclature used herein is merely exemplary and only used for descriptive purposes. Hence, such nomenclature must not be construed as being limiting of the scope of the present disclosure.

The present disclosure will now be described in more detail herein in terms of the above-disclosed exemplary embodiments of system, methods, processes and computer program products. This is for convenience only and is not intended to limit the application of the present disclosure. In fact, after reading the following description, it will be apparent to one skilled in the relevant art(s) how to implement the following disclosure in alternative embodiments.

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims

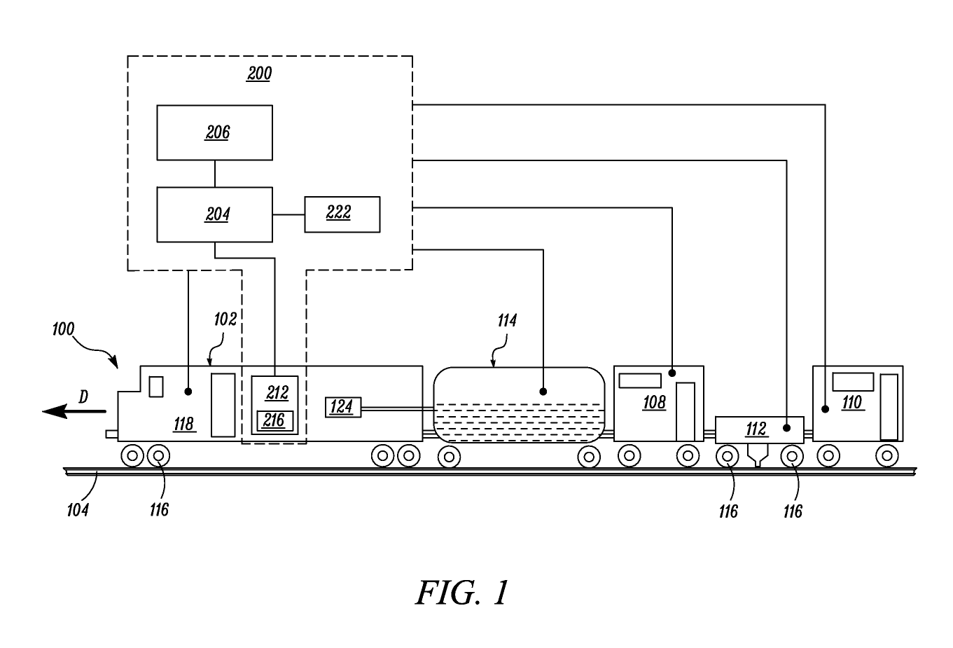

FIG. 1 shows a schematic representation of a locomotive consist 100, in which embodiments of the present disclosure can be implemented. As shown in FIG. 1, the locomotive consist 100 includes a locomotive 102 configured to run on rails 104. The locomotive 102 may be of any type. In one embodiment, the locomotive 102 may be a steam locomotive. In another embodiment, the locomotive 102 may be a diesel locomotive including a gas engine therein. In another embodiment, the locomotive 102 may be an electric locomotive employing one or more pantographs to draw power from an overhead catenary (not shown).

The locomotive consist 100 can further include revenue cars 108, 110 that are coupled one behind the other. The locomotive consist 100 can be powered by the locomotive 102 such that wheels 116 of the revenue cars 108, 110 roll on the rails 104. Although two revenue cars 108, 110 are shown in various embodiments herein, it is to be understood that the number of revenue cars shown is merely exemplarily in nature, and hence, non-limiting of this disclosure. Thus, the locomotive consist 100 may include any number of revenue cars therein without deviating from the scope or spirit of the present disclosure.

In an embodiment as shown in FIG. 1, the locomotive 102 is a puller locomotive i.e., the locomotive 102 is disposed before the revenue car 108 and configured to pull the locomotive consist 100 in a direction of travel ‘D’. However, in another embodiment, the locomotive consist 100 may additionally include a pusher locomotive disposed after the revenue car 110. The pusher locomotive would also be configured to push the locomotive consist 100 in the direction of travel ‘D’. Therefore, in the preceding embodiment, the puller locomotive and the pusher locomotive can co-operatively drive the locomotive consist 100 in the direction of travel ‘D’.

As shown in FIG. 1, the locomotive consist 100 further includes a fuel tender 114. In the illustrated embodiment of FIG. 1, the fuel tender 114 is positioned between the locomotive 102 and the revenue car 108 i.e., adjacent to or nearest in position to the locomotive 102. However, the fuel tender 114 can be optionally located at various other positions relative to the locomotive 102 for e.g., at any position along the locomotive consist 100 depending on specific requirements of an application. Therefore, it should be noted that a position of the fuel tender 114 disclosed herein is merely exemplary in nature and non-limiting of this disclosure.

The fuel tender 114 disclosed herein includes a fuel supply system 122 that is in communication with an engine 124 of the locomotive 102. The fuel supply system 122 could be configured to provide to selectively provide a supply of fuel to the engine 124. A type and/or nature of fuel supplied by the fuel supply system 122 to the engine 124 may depend on a type of the engine used for e.g., Diesel engine, Gas engine, and the like. Therefore, it should be noted that the type and/or nature of fuel supplied by the fuel supply system 122 to the engine 124 is merely exemplary in nature and hence, non-limiting of this disclosure.

Optionally or additionally, as shown in FIG. 1, the locomotive consist 100 could further include a lube car 112 for lubricating the oncoming railroad 104 and/or facilitating an optimum amount of adhesion and hence, tractive effort by the wheels 116 on the railroad 104.

For the purposes of the present disclosure, each of the aforementioned components of the locomotive consist 100 disclosed in FIG. 1 can be regarded as an ‘asset’. Therefore, the following disclosure will be explained using the term ‘asset’ wherever applicable to broadly represent the locomotive 102, any one of the revenue cars 108/110, the fuel tender 114, or the lube car 112 and the term ‘asset’ will henceforth, wherever applicable to the context of this disclosure, be denoted with any one or more of the following numerals ‘102’, ‘108’, ‘110’, ‘112’, and/or ‘114’. As such, it may be noted that in other embodiments, the scope of the term ‘asset’ may vary to include any number and type of components present in a given locomotive consist without deviating from or limiting the scope of this disclosure. Moreover, the present disclosure relates to a system 200 as shown in FIG. 1 for performing asset management of the locomotive consist 100. The terms ‘asset management’ disclosed herein can be construed as being executing of any functionality that is associated with management of one or more asset/s i.e., 102, 108, 110, 112, and/or 114 from the locomotive consist 100. Furthermore, it may be noted that although five assets i.e., 102, 108, 110, 112, and 114 are disclosed herein, a number of assets disclosed herein is non-limiting of this disclosure. Rather, it will be appreciated that in other embodiments, fewer or more assets could be present depending on specific requirements of an application and embodiments of the present disclosure may be implemented in such other configurations of locomotive consists without deviating from the spirit of the present disclosure.

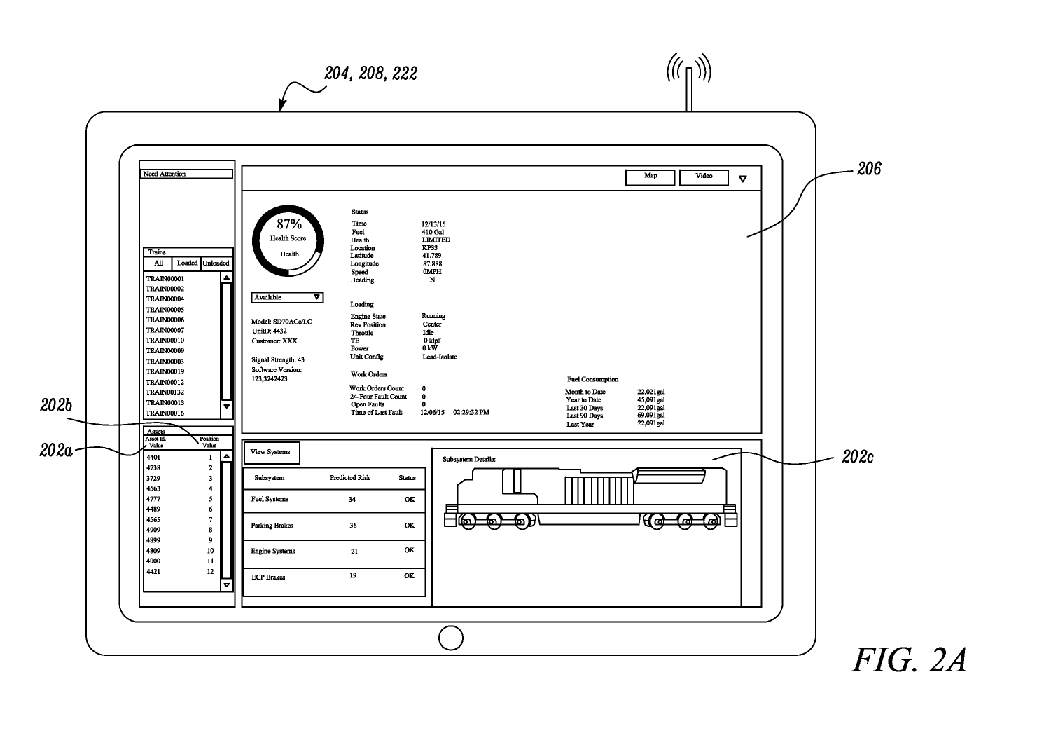

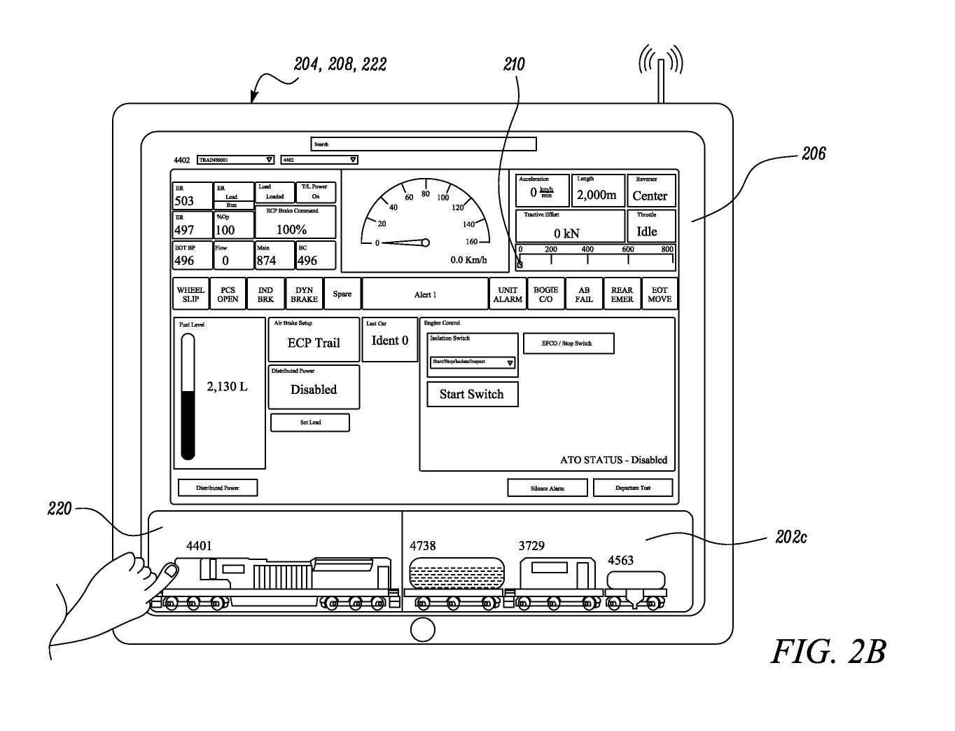

As shown in FIG. 1, the system 200 includes a controller 204 and a graphical user interface 206 (hereinafter simply referred to as ‘GUI’ and referenced with identical numeral ‘206’). The controller 204 and the GUI 206 are communicably coupled to each other and are remotely disposed from the locomotive consist 100. Preferably, the controller 204 and the GUI 206 are beneficially configured to integrally form part of a portable computing device 208 such as that exemplarily shown in FIGS. 2A-2B. In embodiments disclosed herein, the portable computing device 208 is communicably coupled to the locomotive consist 100 over a wireless network such as, but not limited to, a Cellular network, Internet for e.g., Wi-Fi, or a Satellite communication network. A type of wireless network employed between the portable computing device 208 and the locomotive consist 100 is merely exemplary in nature. A person skilled in the art can beneficially contemplate using various other types of wireless networks to dispose the portable computing device 208 in wireless communication with the locomotive consist 100.

Referring to FIGS. 1 and 2A, the controller 204 is configured to receive an asset identification value and a position value for each asset i.e., 102, 108, 110, 112, and 114 present in the locomotive consist 100. As shown in FIG. 2A, a part of the GUI 206 located on the left hand side (L.H.S) of the portable computing device 208 is configured to present, under distinct columns with headers, the ‘asset identification value’, and the ‘position value’, denoted by alpha-numerals ‘202a’ and ‘202b’ respectively. Each of the asset identification values shown in the column 202a of FIG. 2A is indicative of a type of the asset i.e., 102, 108, 110, 112, or 114 present in the locomotive consist 100 of FIG. 1.

Referring to FIG. 2A, the column 202a showing asset identification values includes several types of assets, wherein each asset is denoted with a unique number or the asset identification value for e.g., ‘4401’, ‘4738’, ‘3729’, and so on. Referring now to FIGS. 1, 2A, and 2B, the asset 102 i.e., the locomotive 102 from FIG. 1 is being represented on the GUI 206 in FIGS. 2A-2B with an asset identification value ‘4401’. Similarly, asset 114 i.e., fuel tender 114 from FIG. 1 is now being represented on the GUI 206 in FIGS. 2A-2B with an asset identification value ‘4738’.

Moreover, each of the position values listed in the column 202b of FIG. 2A is indicative of a current position of a given asset i.e., 102, 108, 110, 112, or 114 in the locomotive consist 100 of FIG. 1. Referring to FIG. 2A, the column 202b shows position values for several assets in the locomotive consist of FIG. 1, wherein a unique position value is denoted in the column 202b against each asset identification value from column 202a. Referring now to FIGS. 1, 2A, and 2B, asset 102 i.e., locomotive 102 from FIG. 1 having an asset identification value ‘4401’ is shown having a position value ‘1’ in FIG. 2A. Similarly, the asset 114 i.e., fuel tender 114 from FIG. 1 having an asset identification value ‘4738’ is shown having a position value ‘2’ in FIG. 2A. Therefore, the position value denotes the location of a given asset in the sequence of assets from the locomotive consist 100.

In an embodiment as shown in FIG. 1, the system 200 can additionally include a Global Positioning System (GPS) module 222. The GPS module 222 is communicably coupled to the controller 204 and can hence, beneficially provide a geographical position of each asset i.e., 102, 108, 110, 112, or 114 present in the locomotive consist 100 to the controller 204. Optionally, the controller 204 could also configure the GUI 206 to render the visual representation 202c (See FIG. 2B) of the locomotive consist 100 on a geographical map (not shown) in response to a user-initiated request received at the GUI 206. Accordingly, it is hereby contemplated to provide various user-selectable options on the GUI 206 so that the user can operatively accomplish the above-mentioned functionality from the GPS module 222 at the GUI 206.

Referring to FIGS. 2A-2B, in a further aspect of the present disclosure, the controller 204 is further configured to display, at the GUI 206, a navigable visual representation 202c of the locomotive consist 100 based on the asset identification value (see column 202a of FIG. 2A) and the position value (see column 202b of FIG. 2A) associated with each asset i.e., 102, 108, 110, 112, and 114 present in the locomotive consist 100.

In another aspect of the present disclosure, the controller 204 is also configured to receive, at the GUI 206, a command on the visual representation 202c of the locomotive consist 100 for navigating and requesting a specific asset i.e., 102, 108, 110, 112, and 114 to be called into a user-selectable area 220 of the GUI 206. In the illustrated embodiment of FIG. 2B, an operator is shown providing specific commands for e.g., a swipe gesture on the GUI 206 of the portable computing device 208 to call the asset having asset identification value ‘4401’ i.e., asset 102 or locomotive 102 into the user-selectable area 220 for further operations consistent with the present disclosure.

The controller 204 is then configures the GUI 206 to display at least one characteristic pertaining to the specific asset in response to the specific asset being called into the user-selectable area 220 of the GUI 206. In the illustrated embodiment of FIG. 2B, various characteristics such as wheel slip, a start switch, engine speed, dynamo brake, and other characteristics pertaining to the locomotive 102 is displayed on the GUI 206.

A type and nature of the characteristics displayed by the controller 204 on the GUI 206 for each asset of the locomotive consist 100 may change depending on a type of asset being called into the user-selectable area 220 of the GUI 206. For instance, if the asset having asset identification value ‘4738’ i.e., asset 114 or fuel tender 114 is called into the user-selectable area 220 of the GUI 206, then the controller 204 may trigger the GUI 206 to display various characteristics such as, but not limited to, fuel level remnant in the fuel tender 114, rate of fuel supply for e.g., fuel valve status—open or closed. In another example, if the asset having asset identification value ‘3729’ i.e., asset 108 or revenue car 108 is called into the user-selectable area 220 of the GUI 206, then the controller 204 may trigger the GUI 206 to display various characteristics such as, but not limited to, door status—open or closed, window status—open or closed, wheel-slip, and/or wheel braking Therefore, depending on a type of asset being called into the user-selectable area 220 of the GUI 206, for e.g., asset 102, 108, 110, 112, or 114, the controller 204 may trigger the GUI 206 to display various characteristics that are appropriate or pertaining to the specific type of asset 102, 108, 110, 112, or 114 being called in.

Further, the controller 204 is configured to receive, at the GUI 206, at least one input from the operator for modulating the at least one characteristic pertaining to the asset displayed in the user-selectable area 220 of the GUI 206. For example, as shown in FIG. 2B, upon displaying characteristics of the asset having asset identification value ‘4401’ i.e., asset 102 or locomotive 102, the operator may choose to increase or decrease the throttle associated with the engine 124 of the locomotive 102 by providing a second gesture for e.g., by sliding along the user-selectable key 210.

Thereafter, the controller 204 is configured to modulate, at the locomotive consist 100, the at least one characteristic pertaining to the asset displayed in the user-selectable area 220 of the GUI 206 based on the received input from the operator. The system 200 of the present disclosure may include associated system hardware and/or software on-board the locomotive 100. For example, the system 200 could include transceivers, switches, relays located on-board the locomotive consist 100 that can wirelessly receive and implement the modulation functionality from the controller 204 on the characteristic pertaining to the specific asset i.e., 102, 108, 110, 112, and 114 of the locomotive consist 100.

Moreover, the controller 204 of the portable computing device 208 may be operable via other user-selectable keys (not shown) for modulating various other characteristics or operating parameters pertaining to each asset of the locomotive consist 100. One skilled in the art will appreciate that various other user-selectable actions can be programmed for execution by the controller 204 without deviating from the spirit of the present disclosure. For instance, the system 200 could include another user-selectable key (not shown) at the GUI 206 for modulating a state of a fuel supply valve so that the pressure of fuel supplied by the fuel tender 114 to the engine 124 can be regulated depending on specific requirements of an application. In other examples, the controller 204 may be operable for merely increasing or decreasing an engine speed, for applying brakes associated with specific assets i.e., 102, 108, 110, 112, and 114 of the locomotive 102, for increasing or decreasing a pressure of fuel supplied by the fuel tender 114 to the engine 124 of the locomotive 102 (refer to FIG. 1).

In various embodiments disclosed herein, the controller 204 may be based on integrated circuitry, discrete components, or a combination of the two. In an embodiment, the controller 204 is implemented via a computerized device such as a PC, laptop computer, personal digital assistant (PDA), cellular device, or integrated machine computer which may be configured to serve the functions of controller 204 as well as numerous other machine functions disclosed herein. In the embodiment of FIGS. 2A-2B, the controller 204 is embodied in the form of a dedicated module vis-à-vis the portable computing device 208. In such a case, the controller 204 may be a processor-based device or collection of devices. In an alternative embodiment, the controller 204 could be implemented via an electronic control module (ECM).

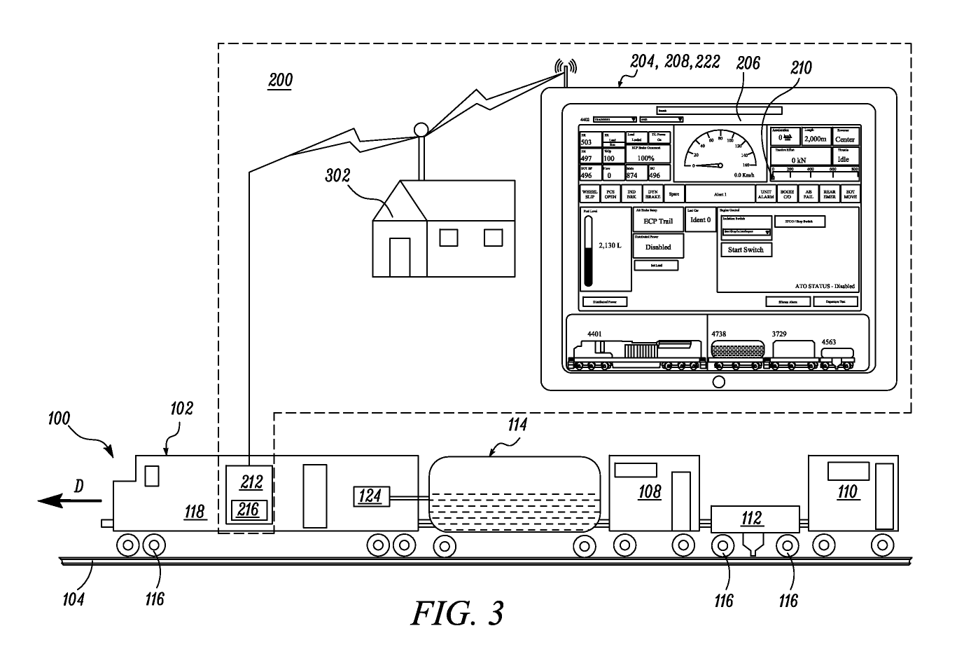

Regardless of how it is implemented, the controller 204 operates, in an embodiment, by executing computer-executable instructions read from a non-transitory computer-readable medium such as a read only memory, a random access memory, a flash memory, a magnetic disc drive, an optical disc drive, and the like. In addition to these instructions, the data processed by the controller 204 may be read from memory in addition to being obtained from one or more of the various machine inputs. The memory may reside on the same integrated circuit device as the processor of the controller 204 or may be, alternatively or additionally, located separately from the controller 204 for e.g., at a remote operator center 302 such as that shown in FIG. 3.

While the controller 204 and its various inputs and outputs can be regarded as being representative of a spoke and hub architecture herein, it will be appreciated that any suitable bus type may be used. For example, in alternative embodiments of this disclosure, inputs and outputs may be serially multiplexed by time or frequency rather than being provided over separate connections. It will be appreciated that peripheral circuitry such as buffers, latches, switches and so on may be implemented within the controller 204 or separately as desired. Because those of skill in the art will appreciate the usage of such devices, they will not be further described herein.

In an embodiment as shown in FIG. 3, a schematic diagram of the remote operator center 302 in conjunction with the system 200 is shown. The remote operator center 302 is configured to facilitate unidirectional or bidirectional communications between the locomotive 102 and the system 200. The remote operator center 302 could beneficially include facilities that allow the operator to wirelessly provide the asset identification values and position values for various assets present in the locomotive consist 100 to the controller 204.

For example, the remote operator center 302 could be a back-office facility where an operator can initialize the asset identification values and position values for various assets present in the locomotive consist 100 to the controller 204. Moreover, if the configuration of the locomotive consist 100 is changed on-field to include other types of assets therein i.e., addition, removal, or modification in the type, number, or position of assets for the locomotive consist 100, then such change can be recorded at the remote operator station 302 for relay to the controller 204. Subsequently, the controller 204 can display via the GUI 206, the changed configuration of the locomotive consist 100 to the controller 204 so that an operator can accordingly call-in assets from the ‘changed’ configuration of the locomotive consist 100 for modulation of respective characteristics.

In an embodiment, the communications between the operator center 302 and the portable computing device 208 is wireless, and may be direct, as in the case of short range wireless communications technology; or may be indirect, as in the case of cellular or other long range communications technologies. In addition, all or some part of such communications may be encrypted or encoded for security purposes. For example, encryption of remote control commands from the controller 204 and/or the remote operator center 302 may prevent unauthorized third parties from controlling an asset i.e., 102, 108, 110, 112, and 114 from the locomotive consist 100 in an unintended or adverse manner.

Therefore, it will be appreciated that in an implementation of the described architecture, the operator center 302 can be suitably adapted for receiving configuration data pertaining to the locomotive consist 100, and monitoring changes in the configuration of the locomotive consist 100, while the portable computing device 208 is configured to communicate with and may receive data pertaining to the assets 102, 108, 110, 112, and 114 in the locomotive consist 100 and also any changes made to the configuration of the locomotive consist 100 from the operator center 302.

In an embodiment as shown in FIG. 3, the system 200 may additionally include a transceiver 212 mounted on-board the locomotive 102. The transceiver 212 may be disposed in communication with the operator center 302 and/or the controller 204. The transceiver 212 may be adapted to wirelessly relay the type and/or position of the assets vis-à-vis the asset identification values and the position values for each of the assets 102, 108, 110, 112, and 114 to the controller 204 and/or the remote operator center 302.

Moreover, data relayed from the transceiver 212 could also be encrypted prior to transmission from the transceiver 212 to the controller 204 and/or the remote operator center 302. Referring to FIG. 3, the transceiver 212 could beneficially include a data encoder 216 therein that can be linked to various mechanical/electrical components present in the assets 102, 108, 110, 112, and 114. These mechanical/electrical components may be operable for changing the characteristics of the specific asset i.e., the asset being called into the user-selectable area 202c of the GUI 206. For example, when the locomotive consist 100 is in transit, and if a door of the revenue car 108 has been ajar, then the mechanical/electrical components associated with the door of the revenue car 108 could actuate the door to be shut. It may be noted that a scope of the present disclosure is not limited by the type and/or number of mechanical/electrical components. Such mechanical/electrical components may include motors, servos, sensors, solenoids, smoke detectors, video cameras, human intrusion detection systems, ground fault detection sensors, pressure sensors, flow rate sensors, and various other components known to one skilled in the art without deviating from the spirit of the present disclosure.

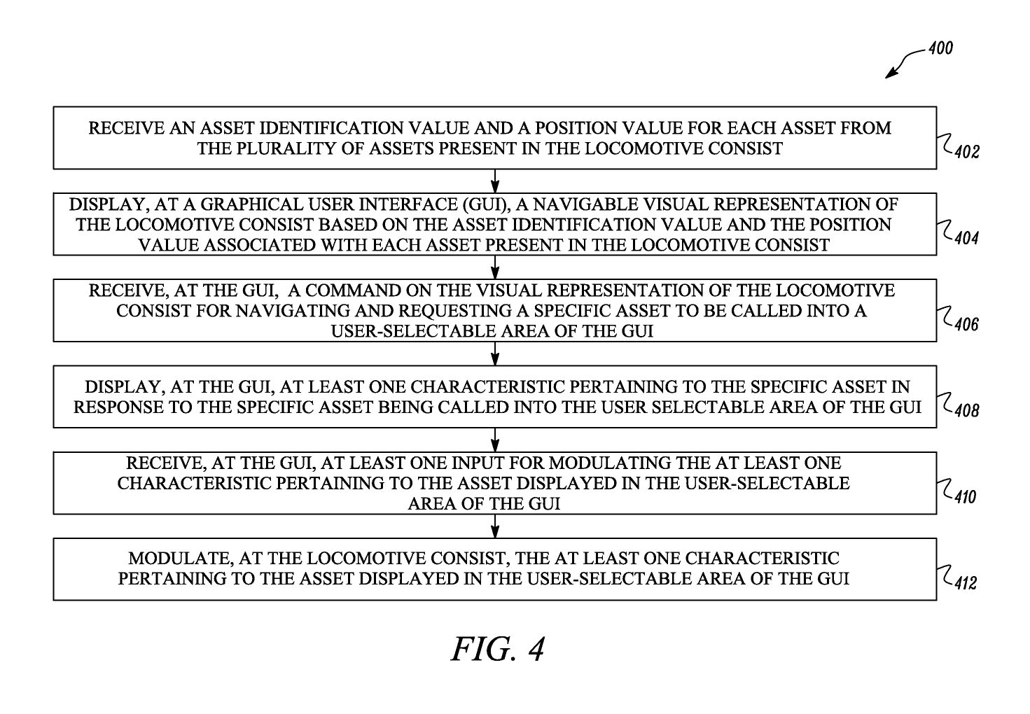

FIG. 4 is a flowchart illustrating a computer-implemented method 400 for performing asset management of the locomotive consist 100, according to an embodiment of the present disclosure.

At step 402, the method 400 includes receiving the asset identification value and the position value for each asset present in the locomotive consist 100. At step 404, the method 400 further includes displaying, at the GUI 206, a navigable visual representation of the locomotive consist 100 based on the asset identification value and the position value associated with each asset i.e., 102, 108, 110, 112, and 114 present in the locomotive consist 100. At step 406, the method 400 further includes receiving, at the GUI 206, a command on the visual representation 202c of the locomotive consist 100 for navigating and requesting a specific asset i.e., 102, 108, 110, 112, or 114 to be called into a user-selectable area 220 of the GUI 206.

Further, at step 408, the method 400 further includes displaying, at the GUI 206, at least one characteristic pertaining to the specific asset i.e., 102, 108, 110, 112, or 114 in response to the specific asset i.e., 102, 108, 110, 112, or 114 being called into the user selectable area 220 of the GUI 206. Furthermore, at step 410, the method 400 further includes receiving, at the GUI 206, at least one input for modulating the at least one characteristic pertaining to the asset i.e., 102, 108, 110, 112, or 114 displayed in the user-selectable area 220 of the GUI 206. Thereafter, at step 412, the method 400 further includes modulating the at least one characteristic pertaining to the asset displayed in the user-selectable area 220 of the GUI 206.

In methodologies directly or indirectly set forth herein, various steps and operations are described in one possible order of operation, but those skilled in the art will recognize that steps and operations may be rearranged, replaced, or eliminated without departing from the spirit and scope of the present disclosure as set forth in the claims

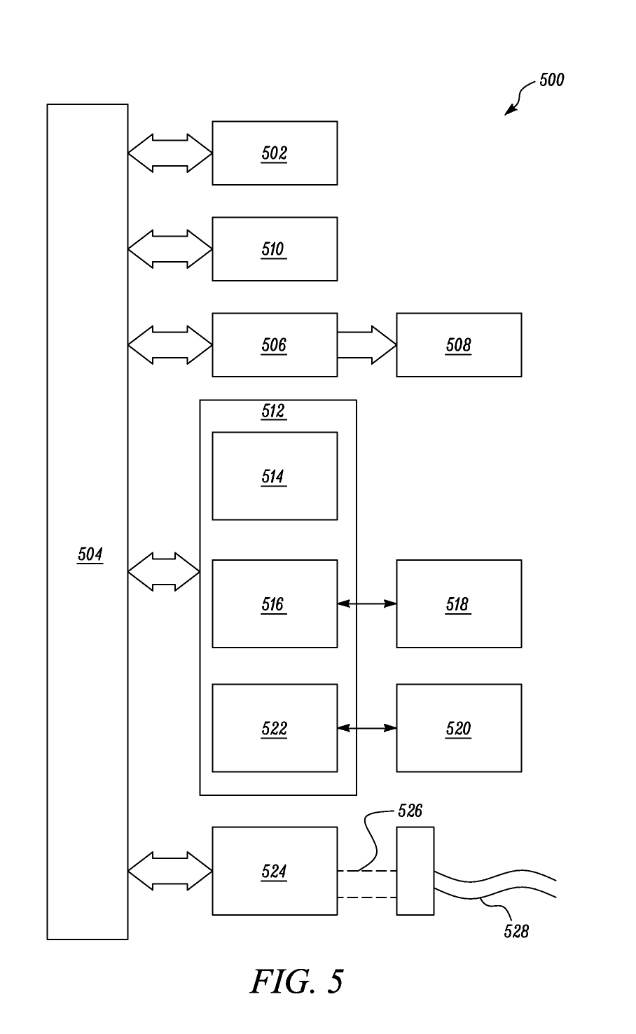

FIG. 5 is a block diagram of an exemplary computer system 500 that can be configured to execute instructions consistent with embodiments of the present disclosure. The present disclosure has been described herein in terms of functional block components, screen shots, schematic circuits (as shown in FIGS. 1-3), and various process steps (as shown in FIG. 4). It should be appreciated that such functional blocks may be realized by any number of hardware and/or software components configured to perform the specified functions. For example, a general purpose machine such as computer system 500, may employ various integrated circuit components, e.g., memory elements, processing elements, logic elements, look-up tables, and/or the like, which may carry out a variety of functions under the control of one or more microprocessors or other control devices. Similarly, the software elements for executing the functions consistent with the present disclosure may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that method 400 may be implemented by employing any number of conventional techniques for data transmission, signaling, data processing, network control, and/or the like. In an embodiment, method 400 may be implemented by the computer 500 using various architecture or platforms such as, but not limited to JavaScript, VBScript, .Net (dot-Net) platform or the like. However, it may be apparent to a person ordinarily skilled in the art that various other software frameworks may be utilized to build the architecture of the computer 500 without departing from the spirit and scope of the disclosure.

These software elements may be loaded onto the general purpose machine or computer 500, a special purpose computer, or any other programmable data processing apparatus, such that the instructions that execute on the computer 500, the special purpose computer, or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce instructions which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

The present disclosure (i.e., system 200, method 400, any part(s) or function(s) thereof) may be implemented using hardware, software or a combination thereof, and may be implemented in one or more computer systems or other processing systems. However, the manipulations performed by the present disclosure were often referred to in terms, such as capturing, receiving, transmitting, modulating, or checking, which are commonly associated with mental operations performed by a human operator. No such capability of a human operator is necessary, or desirable in most cases, in any of the operations described herein, which form a part of the present disclosure. Rather, the operations are machine operations. Useful machines for performing the operations in the present disclosure may include general-purpose digital computers or similar devices.

In fact, in accordance with an embodiment of the present disclosure, the present disclosure is directed towards one or more computer systems capable of carrying out the functionality described herein. An example of the computer-based system includes the computer system 500, which is shown by way of a block diagram in FIG. 5.

Computer system 500 includes at least one processor, such as processor 502. Processor 502 may be connected to a communication infrastructure 504, for example, a communications bus, a crossover bar, a network, and the like. Various software embodiments are described in terms of this exemplary computer system 500. Upon perusal of the present description, it will become apparent to a person skilled in the relevant art(s) how to implement the present disclosure using other computer systems and/or architectures.

Computer system 500 includes a display interface 506 that forwards graphics, text, and other data from communication infrastructure 504 (or from a frame buffer) for display on a display unit 508.

Computer system 500 further includes a main memory 510, such as random access memory (RAM), and may also include a secondary memory 512. Secondary memory 512 may further include, for example, a hard disk drive 514 and/or a removable storage drive 516, representing a floppy disk drive, a magnetic tape drive, an optical disk drive, etc. Removable storage drive 516 reads from and/or writes to a removable storage unit 518 in a well-known manner. Removable storage unit 518 may represent a floppy disk, magnetic tape or an optical disk, and may be read by and written to by removable storage drive 516. As will be appreciated, removable storage unit 518 includes a computer usable storage medium having stored therein, computer software and/or data.

In accordance with various embodiments of the present disclosure, secondary memory 512 may include other similar devices for allowing computer programs or other instructions to be loaded into computer system 500. Such devices may include, for example, a removable storage unit 520, and an interface 522. Examples of such may include a program cartridge and cartridge interface (such as that found in video game devices), a removable memory chip (such as an erasable programmable read only memory (EPROM), or programmable read only memory (PROM)) and associated socket, and other removable storage units 520 and interfaces 522, which allow software and data to be transferred from removable storage unit 520 to computer system 500.

Computer system 500 may further include a communication interface 524. Communication interface 524 allows software and data to be transferred between computer system 500 and external devices. Examples of communication interface 524 include, but may not be limited to a modem, a network interface (such as an Ethernet card), a communications port, a Personal Computer Memory Card International Association (PCMCIA) slot and card, and the like. Software and data transferred via communication interface 524 may be in the form of a plurality of signals, hereinafter referred to as signals 526, which may be electronic, electromagnetic, optical or other signals capable of being received by communication interface 524. Signals 526 may be provided to communication interface 524 via a communication path (e.g., channel) 528. Communication path 528 carries signals 526 and can be implemented using wire or cable lines, fiber optic lines, telephone links, cellular links, radio frequency (RF) links, and/or other communication channels known to one skilled in the art.

In this document, the terms “computer program medium” and “computer usable medium” are used to generally refer to media such as removable storage drive 516, a hard disk installed in hard disk drive 514, signals 526, and the like. These computer program products provide software to computer system 500. The present disclosure is directed to such computer program products.

Computer programs (also referred to as computer control logic) may be stored in main memory 510 and/or secondary memory 512. Computer programs may also be received via the communication interface 504. Such computer programs, when executed, enable computer system 500 to perform the functions consistent with the present disclosure. In particular, the computer programs, when executed, enable Processor 502 to perform the features of the present disclosure. Accordingly, such computer programs represent controllers of computer system 500.

In accordance with an embodiment of the present disclosure, where the disclosure is implemented using a software, the software may be stored in a computer program product and loaded into computer system 500 using removable storage drive 516, hard disk drive 514 or communication interface 524. The control logic (software), when executed by Processor 502, causes Processor 502 to perform the functions of the present disclosure as described herein.

In another embodiment, the present disclosure is implemented primarily in hardware using, for example, hardware components such as application specific integrated circuits (ASIC) Implementation of the hardware state machine so as to perform the functions described herein will be apparent to persons skilled in the relevant art(s).

In yet another embodiment, the present disclosure is implemented using a combination of both the hardware and the software.

Various embodiments disclosed herein are to be taken in the illustrative and explanatory sense, and should in no way be construed as limiting of the present disclosure. All joinder references (e.g., attached, affixed, coupled, engaged, connected, and the like) are only used to aid the reader's understanding of the present disclosure, and may not create limitations, particularly as to the position, orientation, or use of the systems/devices and/or methods disclosed herein. Such joinder references are to be construed broadly. Moreover, such joinder references can infer that two elements or modules are not directly connected to each other.

Further, all numerical terms, such as, but not limited to, “first”, “second”, “third”, or any other ordinary and/or numerical terms, should also be taken only as identifiers, to assist the reader's understanding of the various detectors, embodiments, variations, components, and/or modifications of the present disclosure, and may not create any limitations, particularly as to the order, or preference, of any detector, embodiment, variation, component and/or modification relative to, or over, another detector, embodiment, variation, component and/or modification.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims

### INDUSTRIAL APPLICABILITY

Embodiments of the present disclosure have applicability for implementation and use in performing asset management of a given locomotive consist. Accordingly, embodiments of the present disclosure can help reduce an overall effort and fatigue experienced by operators in managing assets present in the locomotive consist.

With use of embodiments disclosed herein, operators can conveniently monitor an operation and performance of a locomotive consist esp. given the possibility of anomalies that can occur with operation of the assets therein. In some embodiments of this disclosure, when specific anomalies occur, the controller 204 can be optionally configured to trigger the GUI 206 into rendering the appropriate anomalies and thereafter, corrective actions can be taken by the operator by way of user-selectable options provided by the controller 204 on the GUI 206. The operators may operate the controller 204 with appropriate commands so that the controller 204 can in turn wirelessly modulate various characteristics pertaining to a given asset i.e., 102, 108, 110, 112, or 114 in the locomotive consist 100 so as to execute specific functions for e.g., to close an door in the revenue car 108 during operation of the consist 100, to shut-off fuel supply from the fuel tender 114, or the like depending on the type of asset i.e., 102, 108, 110, 112, or 114 being called into the user-selectable area 220 of the GUI 206.

With implementation of the concepts disclosed herein, operators of locomotive systems can be adequately equipped to take informed decisions for changing various characteristics in the operation of the locomotive and/or other assets present in the locomotive consist. Moreover, with use of embodiments disclosed herein, operators can ensure safety, should any inadvertent anomaly or safety concern/issue arise in the operation of the assets of the locomotive consist.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. A system for performing asset management of a locomotive consist, the system comprising:
a controller configured to:
receive an asset identification value and a position value for each asset from a plurality of assets present in the locomotive consist;
display, at a graphical user interface (GUI), a navigable visual representation of the locomotive consist based on the asset identification value and the position value associated with each asset present in the locomotive consist;
receive, at the GUI, a command on the visual representation of the locomotive consist for navigating and requesting a specific asset to be called into a user-selectable area of the GUI;
display, at the GUI, at least one characteristic pertaining to the specific asset in response to the specific asset being called into the user-selectable area of the GUI;
receive, at the GUI, at least one input for modulating the at least one characteristic pertaining to the asset displayed in the user-selectable area of the GUI; and
operably modulate, at the locomotive consist, the at least one characteristic pertaining to the asset displayed in the user-selectable area of the GUI based on the received input.

2. The system of claim 1 further comprising a monitoring station communicably coupled to the locomotive consist and the controller, the monitoring station configured to:
receive the asset identification value and the position value for each asset present in the locomotive consist;
communicate, to the controller, a current state of characteristics pertaining to the specific asset displayed in the user selectable area of the GUI in response to receipt of the asset identification value and the position value for the specific asset.

3. The system of claim 2, wherein the current state of characteristics pertaining to the specific asset includes at least one of: door ajar, window ajar, wheel-slip, wheel braking, engine speed, and rate of fuel supply.

4. The system of claim 1, wherein the controller and the GUI are configured to integrally form part of a portable computing device.

5. The system of claim 4, wherein the portable computing device is at least one of: a personal digital assistant (PDA), a cellular device, a laptop, and a personal computer.

6. The system of claim 1, wherein the asset identification value is indicative of a type of the asset present in the locomotive consist.

7. The system of claim 1, wherein the position value is indicative of a current position of the asset in the locomotive consist.

8. The system of claim 1, wherein the controller is further configured to visually highlight the specific asset in response to the specific asset being called into the user-selectable area of the GUI.

9. The system of claim 1 further comprising a Global Positioning System (GPS) module communicably coupled to the controller, wherein the GPS is configured to provide a geographical position of each asset present in the locomotive consist to the controller.

10. The system of claim 9, wherein the controller configures the GUI to render the visual representation of the locomotive consist on a geographical map in response to a user-initiated request received at the GUI.

11. A computer-implemented method for performing asset management of a locomotive consist, the method comprising:
receiving, at a controller, an asset identification value and a position value for each asset from a plurality of assets present in the locomotive consist;
displaying, at a graphical user interface (GUI), a navigable visual representation of the locomotive consist based on the asset identification value and the position value associated with each asset present in the locomotive consist;
receiving, at the GUI, a command on the visual representation of the locomotive consist for navigating and requesting a specific asset to be called into a user-selectable area of the GUI;
displaying, at the GUI, at least one characteristic pertaining to the specific asset in response to the specific asset being called into the user selectable area of the GUI;
receiving, at the GUI, at least one input for modulating the at least one characteristic pertaining to the asset displayed in the user-selectable area of the GUI; and
modulating, at the GUI, the at least one characteristic pertaining to the asset displayed in the user-selectable area of the GUI.

12. The computer-implemented method of claim 11 further comprising receiving, at the controller, a current state of the characteristics pertaining to the specific asset displayed in the user-selectable area of the GUI in response to receipt of the asset identification value and the position value for the specific asset.

13. The computer-implemented method of claim 12, wherein the current state of characteristics pertaining to the specific asset includes at least one of: door ajar, window ajar, wheel-slip, wheel braking, engine speed, rate of fuel supply.

14. The computer-implemented method of claim 11, wherein the asset identification value is indicative of a type of the asset present in the locomotive consist.

15. The computer-implemented method of claim 11, wherein the position value is indicative of a position of the asset in the locomotive consist.

16. The computer-implemented method of claim 11 further comprising visually highlighting the specific asset in response to the specific asset being called into the user-selectable area of the GUI.

17. The computer-implemented method of claim 11 further comprising:
providing a geographical position of each asset present in the locomotive consist to the controller; and
rendering, at the GUI, the visual representation of the locomotive consist on a geographical map in response to a user-based request received at the GUI.

18. A non-transitory computer-readable medium having stored thereon sequences of instruction, the sequences of instruction including instructions which when executed by a computer-based system for performing asset management of a locomotive consist, causes the computer-based system to execute operations, comprising:
receiving, at the computer-based system, an asset identification value and a position value for each asset from a plurality of assets present in the locomotive consist, wherein the asset identification value is indicative of a type of the asset present in the locomotive consist, and wherein the position value is indicative of a position of the asset in the locomotive consist;
displaying, at a graphical user interface (GUI) of the computer-based system, a navigable visual representation of the locomotive consist based on the asset identification value and the position value associated with each asset present in the locomotive consist;
receiving, at the GUI, a command on the visual representation of the locomotive consist for navigating and requesting a specific asset to be called into a user-selectable area of the GUI;
displaying, at the GUI, at least one characteristic pertaining to the specific asset in response to the specific asset being called into the user selectable area of the GUI; and
receiving, at the GUI, at least one input for modulating the at least one characteristic pertaining to the asset displayed in the user-selectable area of the GUI; and
modulating, at the GUI, the at least one characteristic pertaining to the asset displayed in the user-selectable area of the GUI.

19. The non-transitory computer-readable medium of claim 19 further comprising receiving, by the computer-based system, a current state of the characteristics pertaining to the specific asset displayed in the user selectable area of the GUI in response to receipt of the asset identification value and the position value for the specific asset.

20. The non-transitory computer-readable medium of claim 19 further comprising visually highlighting, by the computer-based system, the specific asset in response to the specific asset being called into the user-selectable area of the GUI.
